(19) United States
(12) Patent Application Publication
(10) Pub. No.: US 2007/0216103 A1
(43) Pub. Date: Sep. 20, 2007

(54) CYLINDER HEAD GASKET FOR INTERNAL COMBUSTION ENGINES

(76) Inventor: Ralf Flemming, Langenbach (DE)

Correspondence Address: Robert L Stearns;Dickinson Wright, 38525 Woodward Avenue, Bloomfield Hills, MI, 48304-2970, US

(21) Appl. No.: 11/568,412

(22) PCT Filed: Apr. 19, 2005
(86) PCT No.: PCT/DE05/00711

§ 371 Date: Oct. 27, 2006

(30) Foreign Application Priority Data
Apr. 27, 2004 (DE) 10 2004 020446.2

(51) Int. Cl. F02F 11/00

(52) U.S. Cl. 277/313

(57) ABSTRACT

Disclosed is a cylinder head gasket for internal combustion engines, comprising a metallic support plate in which passage zones for gaseous and liquid media as well as through-holes for screws are incorporated. Said support plate is made of light metal alloy while being provided with embossed area at least in the region of one of the sealing surfaces thereof, outside the passage zones for the gaseous media, said embossed areas being filled at least in part with an elastomeric material.

### BACKGROUND OF THE INVENTION

1. Technical Field

The invention concerns a cylinder head gasket for internal combustion engines with a metal mounting plate in which transit areas for gaseous and liquid media as well as screw through borings are placed.

2. Related Art

A static gasket is shown in U.S. Pat. No. 6,530,575, having a metal core made of soft steel, which is completely fitted with an elastomer layer in the area of both sealing surfaces. For improved clamping of the elastomer material, the metal core has openings and also temporary flexibility. The elastomer material is applied cold to the associated surface and is tempered in a heated form before it is vulcanized. Profiles that have a triangular cross section are inserted in the elastomer material.

In the German application 199 32 363, a gasket system for the sealing of gasket gaps in internal combustion engines is described, containing a flat gasket that has a microencapsulated sealant in portions of its surface. Housed in the gasket gap is an activator that transforms the sealant in the gasket gap into a foam body by means of a chemical reaction. The flat gasket is formed in such a way that it projects over the gasket gap and extends onto an adjacent component.

The DE 195 07 231 shows a cylinder head gasket for internal combustion engines with a laterally screwed-on chain case or wheel housing. The cylinder head gasket has an elastomer gasket on the face of the end area. A separate sealing element is fitted on the chain case or wheel housing side.

Cylinder head gaskets envisioned in one or multi-layer designs are generally known, in which the individual layers are formed from steel, especially spring steel. The functional features on the combustion chamber side are usually formed in the individual layers and as a rule are made of the same material. Newer technology in internal combustion engines in some cases plans for the use of various substances for the cylinder head and the engine block, or rather their screwed-on parts, so that in the use of steel cylinder head gaskets leakage may occur, which brings with it a harmful corrosive effect on the gasket function of cylinder head gaskets.

### SUMMARY OF THE INVENTION AND ADVANTAGES

The invention is based on the task of further developing an appropriately generic cylinder head gasket, which on the one hand is universally applicable and on the other hand counteracts the problem of leakage with various materials in internal combustion engines.

A cylinder head gasket for internal combustion engines includes a metal support plate made of light metal in which fluid passage zones are provided for conveying a fluid media. The plate includes embossed areas at least in the region of one of the sealing surfaces thereof that are outside the passage zones. The embossments are filled at least in part by elastomeric material.

Light alloys, in contrast to steels, particularly spring steel, are easier to process (moldable), so that the elastomer material can be inserted in the molded area and tempered and vulcanized. The profiles formed project a pre-set amount above the respective face surfaces of the mounting plate and can flexibly give way during compression stress by the engine block or the cylinder head, without the gasket area being damaged.

By using a light alloy, preferably a high-strength aluminum alloy with a tensile strength>200 MPa, the problem of leakage is dealt with, so that unwanted corrosion can no longer occur on the mounting plate, in particular in the gasket areas. For applying the elastomer material, [[the]] a so-called Liquid Elastomer Molded (LEM) process is used, which was already described in U.S. Pat. No. 6,530,575 which disclosure is incorporated herein by reference.

Such a cylinder head gasket, having a mounting plate made of light alloy in combination with the embossed area at least partially filled with the elastomer material, is universally applicable.

For special cases of application, as for example with internal combustion engines, in which the lubricated drive chain oil is lead in a separate chain case, the following advantageous modifications of the cylinder head gasket can also be made:

The mounting plate can seal T-shaped formed gasket gaps in internal combustion engines in the area of the limiting edge facing the gasket gap and be provided there with elastomer material, which joins into the area of at least one, but preferably in the area of both mounting plate sealing surfaces in associated embossed areas in the mounting plate.

Alternatively, the mounting plate for sealing T-shaped formed gasket gaps in internal combustion engines can project over the gasket gap, in which the mounting plate in the area of the gasket gap has at least one corresponding recess or embossment that is at least partially filled with elastomer material, which blends into the area of at least one, but preferably in the area of both mounting plate sealing surfaces in associated embossed areas in the mounting plate.

Through these designated measures in the area of the mounting plate, the gasket problem in the linking area of the chain case on the engine block and cylinder head can be solved in an easy way, in which no damaging leaks to the sealant effect can occur due to the mounting plate being made of light alloy and thus eliminating the effect of corrosion.

Another idea for the invention is the possibility of producing the respective combustion chamber side functional area of the cylinder head gasket from material diverging from the mounting plate material, for example in the usual manner from steel, especially spring steel, in a one- or multilayer design. The functional area can either be loosely guided within the mounting plate or solidly joined with the same. The respective functional area can contain ribbing in the usual way (half ribbing or full ribbing), temporarily in connection with stopping elements.

Embodiments of invention are represented in the drawings and are described as follows:

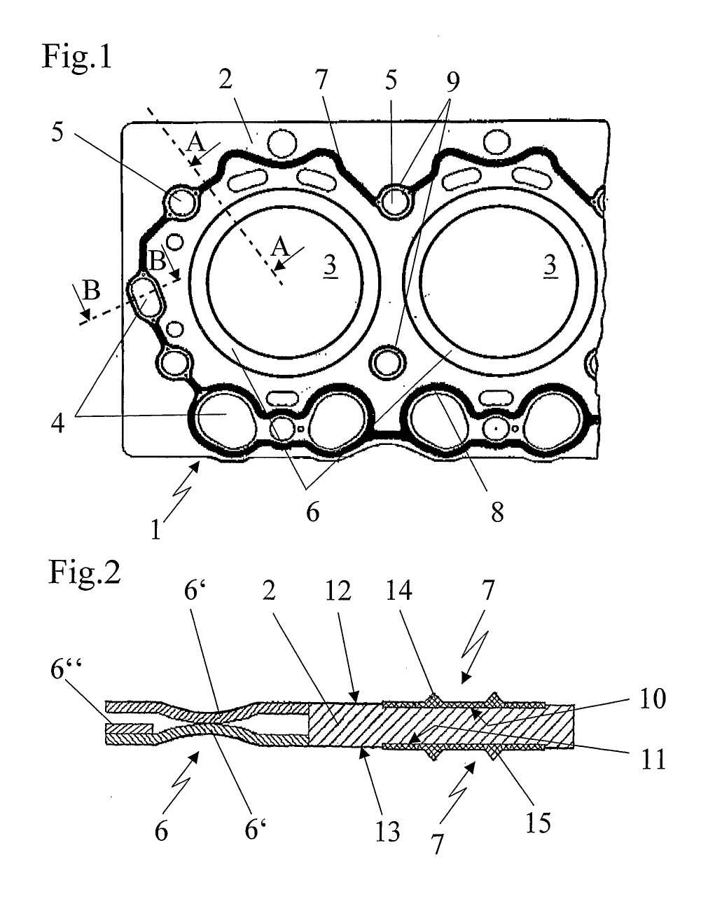

FIG. 1 is a fragmentary plan view of a cylinder head gasket for an internal combustion engine;

FIG. 2 is a section along line A-A of FIG. 1;

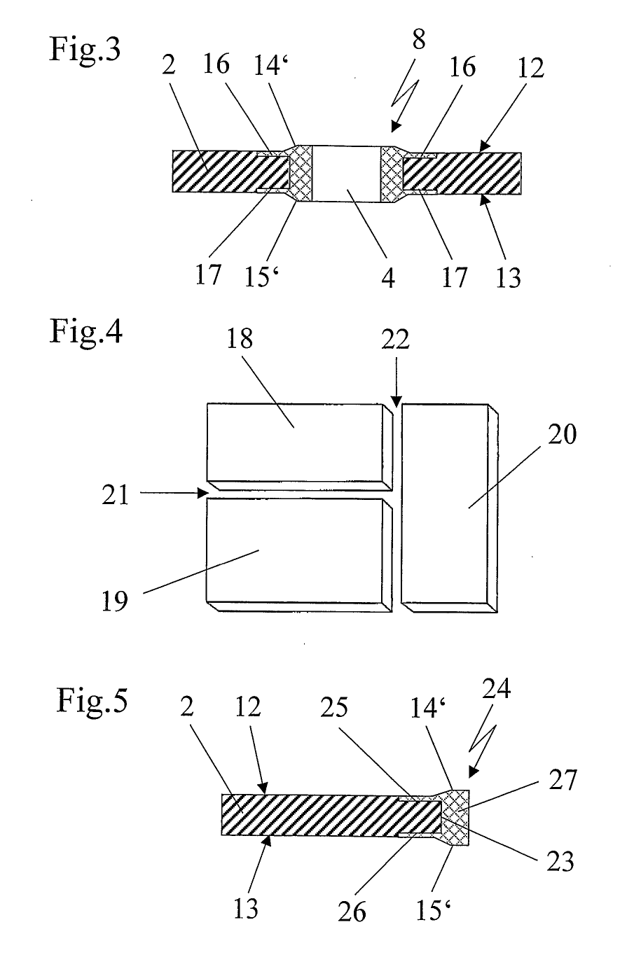

FIG. 3 is a section along line B-B of FIG. 1;

FIG. 4 is a schematic plan view of an internal combustion engine design having a T-gap;

FIG. 5 is a cross-sectional view of a mounting plate, in connection with a gasket area for sealing the T-gap according to FIG. 4;

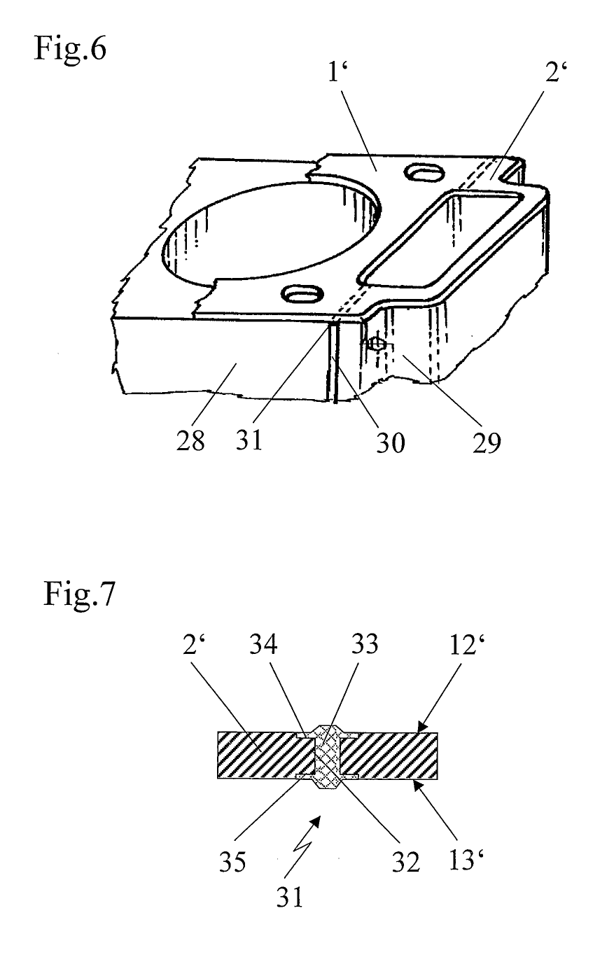

FIG. 6 is a fragmentary perspective view of an internal combustion engine together with cylinder head gasket according to an alternative embodiment; and

FIG. 7 is a cross-sectional view of a mounting plate with additional gasket position for sealing the T-gap according to FIG. 6.

### DETAILED DESCRIPTION

FIG. 1 shows as principle outline a cylinder head gasket 1I for an internal combustion engine. The cylinder head gasket 1 includes a mounting plate 2, in this example made of a high-strength aluminum alloy with a tensile strength of 250 MPa, which has open areas or passage zones 3 for gaseous media, area 4 for fluid media as well as an appropriate number of screw openings 5. The combustion chamber side functional area 6 comprises a substance diverging from the material of mounting plate 2, in this example of spring steel and should be solidly connected with the mounting plate 2. Outside of the transit area 3 for the gaseous media, the mounting plate 2 is provided with molded or recessed or embossed areas (not shown in this figure), which are at least partially filled with an elastomer material 7, 8, 9. The molded areas, in connection with the elastomer material 7, 8, blend at least partially into each other.

FIG. 2 shows a section according to line A-A of FIG. 1. Shown is the mounting plate 2 made of aluminum alloy, the functional area 6, molded areas 10, 11 in the area of both sealing surfaces 12, 13 of mounting plate 2 as well as elastomer material 7. The molded areas 10, 11 have a pre-set width. The elastomer material 7 was placed in the molded areas 10, 11 according to the LEM process, in which over the course of the vulcanization, profile 14, 15 in the area of the elastomer material 7 were formed, which extend slightly above the associated gasket surface 12, 13 of mounting plate 2 and during the assembly of engine block and cylinder head can flexibly give way. Damage to the elastomer material 7 thus does not occur. The functional area 6 is formed in multiple layers in this example, in which the individual site is provided with embossed beads 6′. In addition, a stopping element 6″ is provided. The functional area 6 is solidly joined with the mounting plate 2 in this example.

FIG. 3 shows a section according to line B-B of FIG. 1. Shown is the mounting plate 2 made of aluminum alloy, as well as the elastomer material 8 inserted therein, which likewise features profile 14′, 15′, which projects above the gasket surfaces 12, 13 of mounting plate 2 by a pre-set amount. During assembly, the elastomer material 8 can flexibly give way to the associated open area 4, so that no damage of the elastomer material 8 occurs here either. For improved clamping of the elastomer material 8 on the mounting plate 2, embossed areas 16, 17 are provided in the area of both gasket surfaces 12, 13, which the elastomer material 8 leads into.

FIG. 4 shows a possible design of an internal combustion engine, having a cylinder head 18, an engine block 19 and a chain case 20. In the gap 21 between cylinder head 18 and engine block 19, a cylinder head gasket not pictured here is positioned (for instance one according to FIG. 1), which also partially overlaps the gap 22 between cylinder head 18, engine block 19 and chain case 21. The gaps 21, 22 define the so-called T-interface forming a T-gap.

FIG. 5 again shows mounting plate 2 made of aluminum alloy, which is used for the design according to FIG. 4. In the area of the limiting edge 23 facing gap 22 of mounting plate 2, an additional flexible gasket area 24 is formed. Recessed or embossed areas 25, 26 in the area of both gasket surfaces 12, 13 are also provided, which receive the elastomer material 27 of gasket area 24. The gasket area 24 is also provided with profiles 14′, 15′.

FIG. 6 shows a cutout of a gasket system in a perspective view that should be applicable for sealing the gasket gap in an alternatively formed internal combustion engine. The gasket system is made of a cylinder head gasket 1′, which contains a mounting plate 2′ made of a high strength aluminum alloy. A component 29 is mounted on the side of the engine block 28, which functions as chain case or wheel housing. The seal between engine block 28 and component 29 is provided by a separate vertical running flat gasket 30. The gasket gap 31 to be sealed turns out to be tolerant-conditioned through the components 1′, 28, 29, 30. The cylinder head gasket 1′ is designed so that it juts out across the gap 31 and over the end of the component 29.

FIG. 7 now shows the mounting plate 2′ made of aluminum alloy, which in the area of the critical gasket gap 31 is provided with a corresponding recess 32 and is at least partially filled with an elastomer material 33 that projects slightly over the face surfaces 12′, 13′ of the mounting plate, and with clamping of the components is squeezed into and penetrates the gasket gap 31 and in this way secures the corresponding seal in this example. Embossed areas 34, 35 are also provided that receive the elastomer material 33.

1-17. (canceled)

18. A cylinder head gasket for an internal combustion engine comprising:
a metal mounting plate made of light metal alloy in which open areas for gaseous and fluid media as well as screw through borings are provided, characterized by the mounting plate consisting of a light metal alloy, and wherein said mounting plate outside of said open areas for the gaseous media are formed with recessed areas in at least one gasket surface that are at least partially filled with an elastomer material.

19. The cylinder head gasket according to claim 18, wherein said elastomer material is provided with a sealing profile projecting above an outer surface of said gasket plate.

20. The cylinder head gasket according to claim 18, wherein said elastomer material extends along a circumferential region of the gasket.

21. The cylinder head gasket according to claim 18, wherein said open areas for the gaseous media and/or the screw openings are provided at least partially with annular recessed areas at least partially being filled with profile elastomer material.

22. The cylinder head gasket according to claim 18 wherein there are different regions of elastomer material that at least partially merge into each other.

23. The cylinder head gasket according to claim 19 wherein said profile is rib-like with a triangular cross section.

24. The cylinder head gasket according to claim 18 wherein said mounting plate consists of a high-strength aluminum alloy.

25. The cylinder head gasket according to claim 24, wherein said high-strength aluminum alloy has a tensile strength>200 MPa.

26. The cylinder head gasket according to claim 18, wherein said mounting plate is adapted for sealing T-shaped formed gasket gaps in internal combustion engines and includes a limiting edge ending on the gasket gap side and being fitted with elastomer material and including recessed areas in the mounting plate surfaces adjacent said limiting edge in which said elastomer material of said limiting edge is partially received.

27. The cylinder head gasket according to claim 18 wherein said mounting plate is adapted for the sealing T-shaped formed gasket gaps in internal combustion engines in which an extended portion of said mounting plate juts over the gasket gap, and said mounting plate in the area of the gasket gap includes at least one corresponding recess that is filled with elastomer material and that adjacent thereto is an embossment formed in both gasket surfaces of the mounting plates that receives a portion of the elastomer material.

28. The cylinder head gasket according to claim 27 wherein the elastomer projects above said gasket surfaces at least in the area of the gasket gap.

29. The cylinder head gasket according to claim 28 wherein said elastomer material is formed with a profile.

30. The cylinder head gasket according to claim 18 including a combustion chamber side functional area of the cylinder head gasket being constructed of spring steel.

31. The cylinder head gasket according to claim 30 wherein said combustion chamber side functional area is permanently connected with said mounting plate.

32. The cylinder head gasket according to claim 30 wherein said combustion chamber side functional area being combined in an integrated formed functional area.

33. The cylinder head gasket according to claim 30 wherein said combustion chamber side functional area being formed in multiple layers, in which at least one bead is provided on the combustion chamber side.

34. The cylinder head gasket according to claim 33 including at least one stopping element provided on the combustion chamber side.
